(19) United States
(12) Patent Application Publication
(10) Pub. No.: US 2004/0047961 A1
(43) Pub. Date: Mar. 11, 2004

(54) Protein-rich, low-calorie food preparation for pizza-type products and the preparation method thereof

(76) Inventor: Reginald Allouche, Paris (FR)

Correspondence Address: PIPER RUDNICK, P. O. BOX 64807, CHICAGO, IL, 60664-0807, US

(21) Appl. No.: 10/381,081

(22) PCT Filed: Jun. 24, 2002
(86) PCT No.: PCT/FR02/02180

(30) Foreign Application Priority Data
Jun. 22, 2001 (FR) 01/08268

(51) Int. Cl. A21D 10/00

(52) U.S. Cl. 426/549

(57) ABSTRACT

The invention relates to a protein-rich, low-calorie food preparation in the form of round, oval, rectangular or square garnished dough for the production of products that imitate or resemble traditional pizza-type products. The inventive preparation is characterised in that it contains in percentages expressed in weight of the commercial product:—a total protein content (measured in N×6.25) of between 8.5 and 28%, preferably between 10 and 20% and, better still, between 10 and 18%;—a carbohydrate content of between 11 and 29%, preferably between 11 and 20% and, better still, between 12 and 18%;—a lipid content of between 1 and 10%, preferably between 1.5 and 7% and, better still, between 2 and 6%—a water content of between 10 and 40%; and a caloric value of between 90 and 200 Kcal per 100 g and preferably between 130 and 180 Kcal per 100 g.

The present invention concerns a food preparation in the form of a round, oval, rectangular or square dough with topping, which may be provided at room temperature (packaging under a controlled atmosphere, for example) or in a deep-frozen state. This food preparation is intended to be baked or simply heated at the time of consumption, in order to obtain products imitating or resembling traditional pizza-type products, and is characterized by a high content of proteins and a low content of carbohydrates and of lipids. It is therefore both rich in protein and low in calories.

Traditional pizza-type products are, par excellence, products which are difficult to integrate into a diet because they contain a high level of lipids and carbohydrates, which markedly restrict their consumption.

While it is evident that consumers are increasingly mindful of their physical appearance and that they do not therefore wish to gain weight, it is also true that they nevertheless wish to continue to enjoy eating, that is to say by eating tasty products to satiety. They are therefore increasingly led to turn to multiple so-called “slimming” diets which are most generally characterized by a lower daily calorie intake, obtained by a lower quantity of ingested foods which is most often associated with a reduction in the content of lipids.

Unfortunately, these diets are difficult to adhere to over a long period and cause a loss of weight linked to a loss of muscle mass. A lack of skin tone and elasticity, and a physical and intellectual asthenia are then observed. In addition, people strictly following these diets do not eat as much as they would like to and therefore suffer from hunger and feel frustrated.

A need therefore exists to have diet products which, while being low in calories, do not cause the harmful consequences indicated above and which allow the consumer to follow a diet with pleasure, that is to say which allow them to eat to satiety and to lose their fatty mass, without this being at the expense of their lean mass.

It is recognized that it would be necessary to provide the body, during these periods of calorie reductions, with a higher supply of proteins of high nutritional and biological value.

However, this additional constraint further complicates the exercise of formulating food compositions which are, at the same time, low in calories, industrializable, organoleptically satisfactory, stable from the point of view of aging and which are easy to prepare, without adding fat.

This is even more arduous in the case of pizza-type products because the dough base should satisfy many requirements both in terms of manufacturing constraints and in terms of the organoleptic, visual and textural characteristics (permeability, absorbability, softness, coloration in particular) of the product.

It is indeed known that the manufacture of such a pizza-type product comprises a number of steps such as:

kneading,

forming on a forming machine,

successive laminations,

automated or manual handling,

deposition of the topping,

cooking

which must each correspond to well defined conditions.

Thus, the kneading should lead to a nonsticky and elastic dough. As for the forming on a forming machine, it should be carried out without sticking to the equipment.

It should in particular be possible to properly work the dough base at the level of the laminating operation. It should indeed be sufficiently resistant and elastic to be able to undergo lamination in a given direction, possibly a turning over, and then a second lamination in the transverse direction. Neither tearing nor retraction should be observed, the edges of the galette formed should be as regular as possible and remain substantially flat on resting, all the more so since the galette in question is generally still handled, manually or automatically, after the laminating operation, before deposition of the topping.

The deposition of this topping also brings about very strict requirements in terms of the texture of the dough base: the topping should indeed not be able to pass through the dough base, nor be too highly absorbed. It should therefore remain at the surface without excessively impregnating the galette.

Finally, in terms of the cooking, the dough should remain cream-colored or light-beige in color while exhibiting pronounced cooking marks. This is extremely difficult to obtain when the proportion of proteins is too high, because proteins tend to lead to a brick-red color.

Moreover, it is also necessary to ensure that the dough does not rise excessively and does not bulge. As regards the topping itself, it should also satisfy a number of desiderata. It should thus contain a high protein content, without the color and the texture being too modified as a result compared to those of a traditional pizza, and while being organoleptically satisfactory.

Moreover, the texture after cooking should resemble that of a tomato puree without there being excessive smoothing or sticking because of the high protein content.

All these constraints are obviously very specific to pizza-type products and have nothing in common with those required for a traditional bread-type product.

However, the Applicant has the merit of having succeeded in developing, after numerous trials, a food preparation which, once prepared, gives products resembling or imitating traditional pizza-type products and which are at the same time rich in proteins, low in calories, organoleptically satisfactory, stable from the texture point of view, and easy to prepare.

Said food preparation is provided in the form of a fresh, deep-frozen, precooked or cooked preparation. Although it is possible to provide this preparation in the form of a separate dough and a separate topping, the reconstitution of the pizza-type product then being directly carried out at the time of the final step of the preparation before consumption, it is preferable to provide it in the form of a preparation with topping, that is to say already comprising the topping. Most generally, the preparations in question are provided in a precooked or cooked form, at room temperature (the packaging being most generally carried out under a controlled atmosphere) or in a deep-frozen form, requiring a cooking or heating step before consumption.

The preparation with topping is characterized in that it has, the percentages being expressed by weight on the commercial product:

a total protein content (measured as N×6.25) of between 8.5 and 28%,

a carbohydrate content of between 11 and 29%,

a lipid content of between 1 and 10%,

a water content of 10 to 50%,

a calorific value of between 90 and 200 Kcal per 100 g.

Preferably, the food preparation according to the invention has:

a total protein content (measured as N×6.25) of between 10 and 20%, preferably between 10 and 18%, and still more preferably between 10 and 16%,

a carbohydrate content of between 11 and 20%, preferably between 12 and 18%, and still more preferably between 12.5 and 16%,

a lipid content of between 1.5 and 7%, preferably between 2 and 6%, and still more preferably between 2 and 5%,

a water content of 10 to 40%.

The total calorific value of the commercial product is preferably between 130 and 180 kcal/100 g, and still more preferably between 130 and 170 kcal/100 g.

The food preparation according to the invention is also characterized in that its chemical value is greater than 100. It is recalled that the expression chemical value is understood to mean the product by 100 of the smallest of the quotients obtained by dividing, for each of the essential amino acids or groups of essential amino acids, the quantity present in 100 g of product by the corresponding quantity present in 100 g of protein serving as reference, the latter being characterized by the following contents expressed relative to 100 g:

| | | |
|---|---|---|
| L isoleucine | 4 | g |
| L leucine | 7 | g |
| L lysine | 5.5 | g |
| DL methionine + L cystine | 3.5 | g |
| L phenylalanine + L tyrosine | 6 | g |
| L threonine | 4 | g |
| L tryptophan | 1 | g |
| L valine | 5 | g |

The proteins used for constituting the food preparation in accordance with the invention may be of animal and/or plant origin.

For the dough base, it is preferable to use, as essential source of proteins (other than those obtained from flour) milk proteins, such as caseine, caseinates, total milk protein, lactalbumin, whey. Total milk protein is preferably used. It is also possible to add gluten, especially from wheat, and textured proteins, especially extruded soybean proteins.

As regards the topping, it is preferable to use extruded proteins, in particular vegetable proteins such as soybean. These textured proteins have the advantage of binding to the tomato puree without denaturing it and without changing its color too markedly.

The topping/tart base weight ratio is generally between 1/3 and 1/1, preferably between 1.5/3 and 2.5/3, and still more preferably in the region of 2/3.

As carbohydrates, it is possible to use flours of any origin, any type of starch, of any origin, whether native or modified, in particular corn starches and wheat starches, and sugars and polyols.

As lipids, it is preferable to use fat from copra, palm, soybean or sunflower in powdered or liquid form.

Of course, the preparation in accordance with the invention may also contain other conventional ingredients such as flavorings, salt, thickeners, amino acids, spices, condiments, taste enhancers, preservatives, colorings, vitamins, minerals, soluble or insoluble fibers such as in particular insulin or glucose or fructose polymers, emulsifiers, leavening powders or yeasts and intense sweeteners.

The topping may contain, in addition, vegetable, fresh or deep-frozen meat, fresh or deep-frozen fish, cheese or fruit pieces, puree or powder.

According to a preferred embodiment of the invention, the preparation with topping according to the invention contains:

from 2 to 10%, preferably from 2.3 to 10%, and still more preferably from 2.3 to 9.5% of milk proteins, total milk proteins being preferred,

a flour, preferably wheat flour, in a quantity generally of between 13 and 35%, preferably between 13 and 25%, and still more preferably between 13 and 22%,

a leavening agent, such as baker's or brewer's yeast, this leavening agent being most generally present in a quantity of between 0.1 and 1.2%, preferably between 0.1 and 1.1%, and still more preferably between 0.15 and 1%,

tomato, preferably in puree form, in a quantity of between 15 and 35%, preferably between 16 and 34%,

vegetable and/or animal proteins, in particular soybean proteins and in particular in textured form, in a quantity of between 1 and 20, preferably between 1 and 15, and still more preferably between 1 and 10%.

For its preparation, water is added in a quantity of 10 to 30%, preferably 12 to 30%, and still more preferably 15 to 27%, which leads to a final moisture of about 10 to about 50%, preferably of about 10 to about 40%, on the finished product.

The subject of the invention is also the method for making the food preparation according to the invention.

This method comprises the following steps:

weighing the ingredients for the dough base, these being most generally in powdered form,

mixing said ingredients,

adding a chosen quantity of water to a kneader-type apparatus, and kneading for a defined time, generally of between 5 minutes and 30 minutes, preferably between 10 minutes and 20 minutes,

optionally adding an additional quantity of water, and mixing,

forming dough pieces, in particular on a forming machine-type apparatus,

resting the dough pieces thus formed, for example by passing onto a swing-tray,

laminating operation, the latter most generally comprising several successive laminations, and optionally cutting

weighing of the various ingredients of the topping, and then mixing said ingredients, optionally accompanied by grinding,

depositing the topping thus prepared on the laminated and optionally cut dough, and spreading the topping over substantially the entire surface of the tart base, up to 1 cm from the edge approximately,

depositing the other ingredients in pieces and grated cheese on the dough,

cooking, preferably on wood fire, for a sufficient time to obtain the desired coloration,

optionally deep-freezing,

individually packaging the products with topping thus obtained, and placing in boxes.

Preferably, the various ingredients for the preparation of the dough base are mixed in the following order of introduction:

1) flour, protein, oil, leavening agent of the brewer's yeast type,

2) mixing of the powders,

3) adding most of the water to the kneader,

4) mixing, generally for 5 minutes to 30 minutes,

5) adding the remainder of the water,

6) mixing, for 5 minutes to 15 minutes, preferably of the order of 10 minutes approximately,

7) adding salt, and then mixing further for about 5 minutes.

The dough pieces, generally formed on a forming machine, preferably have a weight of about 200 grams, and the passage onto the swing-tray, in order to ensure a rest time for the dough, lasts for about 5 minutes to 30 minutes. The cooking on wood fire is generally carried out for 50 seconds to 2 minutes, and preferably for about 1 minute.

The preparation, for consumption, of the pizza-type products thus prepared is generally carried out by heating in a traditional oven.

The invention will be understood more clearly with the aid of the following examples which are given purely by way of illustration.

### EXAMPLES

Several tests for the making of dough base and topping were carried out with the aid of the ingredients presented in Table 1 below.

TABLE 1

| INGREDIENTS | TEST 1 | TEST 2 | TEST 3 |
|---|---|---|---|
| DOUGH BASE | | | |
| Wheat flour 55 | 77.04 | 73.08 | 92.8 |
| Total milk protein PL 80 | 34.06 | 32.31 | 21.88 |
| (Triballat) | | | |
| Salt | 2.71 | 2.57 | 2.76 |
| Sunflower oil | 2.17 | 2.06 | 1.38 |
| Yeast | 2.71 | 2.57 | 2.87 |
| Water | 81.31 | 87.41 | 78 |
| TOPPING | | | |
| Tomato | 151.84 | 151.84 | 107.8 |
| Extruded soybean protein | 0 | 0 | 19.5 |
| (Markal) | | | |
| Spices | 0 | 0 | 1 |
| Mushroom | 100 | 100 | 55 |
| Total milk protein PL 80 | 20.51 | 20.51 | 0 |
| (Triballat) | | | |
| Whey protein WPC90 | 27.65 | 27.65 | 0 |
| (Triballat) | | | |
| Cheese | 0 | 0 | 53 |
| Diced chicken | 0 | 0 | 53 |
| Water | 0 | 0 | 11 |
| Total | 500 g | 500 g | 500 g |
| Proteins (per 100 g of | 15.97 | 15.61 | 12.9 |
| product) | | | |
| Carbohydrates (per 100 g of | 12.68 | 12.10 | 15.13 |
| product) | | | |
| Lipids (per 100 g of | 1.11 | 1.07 | 4.26 |
| product) | | | |

The following remarks may be made in relation to these tests:

Test 1: the dough in the kneader is too dry and brittle. It does not withstand lamination. To improve the elasticity of this dough, it is necessary to increase the water and reduce the addition of proteins in relation to the flour.

Test 2: the color of the topping is very pale in relation to traditional toppings. This color is due to the presence of milk proteins mixed with tomato. The taste is also too acrid and bitter.

Test 3: the incorporation of extruded proteins into the tomato confers on the pizza a satisfactory and novel “bolognese” type taste. The protein and flour level is reduced in order to obtain an elastic dough whose edges are smooth, non-crackled and continuous.

A pizza-type product is then obtained, after cooking in a traditional domestic oven type apparatus for about 15 minutes, which is texturally, visually and organoleptically satisfactory, while being low in calories and rich in proteins.

1. A protein-rich and low calorie food preparation in the form of a dough with topping, for making products imitating or resembling traditional pizza-type products, characterized in that it has, the percentages being expressed by weight on the commercial product:
a total protein content (measured as N×6.25) of between 8.5 and 28%,
a carbohydrate content of between 11 and 29%,
a lipid content of between 1 and 10%,
a water content of 10 to 50%,
a calorific value of between 90 and 200 Kcal per 100 g.

2. The food preparation as claimed in claim 1, characterized in that it has, the percentages being expressed by weight on the commercial product:
a total protein content (measured as N×6.25) of between 10 and 20%, preferably between 10 and 18%, and still more preferably between 10 and 16%,
a carbohydrate content of between 11 and 20%, preferably between 12 and 18%, and still more preferably between 12.5 and 16%,
a lipid content of between 1.5 and 7%, preferably between 2 and 6%, and still more preferably between 2 and 5%,
a water content of 10 to 40%,
a calorific value of between 90 and 200 Kcal per 100 g.

3. The food preparation as claimed in either of claims 1 and 2, characterized in that it comprises a flour, preferably wheat flour, in a quantity of between 13 and 35%, preferably between 13 and 25%, and still more preferably between 13 and 22%, these percentages being expressed by weight on the commercial product.

4. The food preparation as claimed in any one of claims 1 to 3, characterized in that it has a milk protein content of 2 and 10%, preferably between 2.3 and 10%, and still more preferably from 2.3 to 9.5%, these percentages being expressed by weight on the commercial product.

5. The food preparation as claimed in any one of claims 1 to 4, characterized in that it contains a leavening agent, preferably baker's or brewer's yeast, in a quantity of between 0.1 and 1.2%, preferably between 0.1 and 1.1%, and still more preferably between 0.15 and 1%, these percentages being expressed by weight on the commercial product.

6. The food preparation as claimed in any one of claims 1 to 5, characterized in that it contains tomato, preferably in puree form, in a quantity of between 15 and 35%, and preferably between 16 and 34%, these percentages being expressed by weight on the commercial product.

7. The food preparation as claimed in any one of claims 1 to 6, characterized in that it contains vegetable proteins, in particular from soybean and in particular in textured form, in a quantity of between 1 and 20%, preferably between 1 and 15%, and still more preferably between 1 and 10%, these percentages being expressed by weight on the commercial product.

8. The food preparation as claimed in any one of claims 1 to 7, characterized in that a quantity of water of between 10 and 30%, preferably between 12 and 30%, and still more preferably between 15 and 27%, is added for its preparation.

9. The food preparation as claimed in any one of claims 1 to 8, characterized in that the total calorific value of the commercial product is between 130 and 180 Kcalories per 100 g, and preferably between 130 and 170 Kcalories per 100 g.

10. The food preparation as claimed in any one of claims 1 to 9, characterized in that its chemical value is greater than 100.

11. The food preparation as claimed in any one of claims 1 to 10, characterized in that the milk protein is a total milk protein.

12. The food preparation as claimed in any one of claims 1 to 11, characterized in that the topping comprises tomato puree, extruded proteins, vegetable and/or meat and/or fish pieces.

13. A method for making a food preparation as claimed in any one of claims 1 to 12, characterized in that it comprises the following steps:
weighing the ingredients for the dough base,
mixing said ingredients,
adding a chosen quantity of water to a kneader-type apparatus, and kneading for a defined time, generally of between 5 minutes and 30 minutes, preferably between 10 minutes and 20 minutes,
optionally adding an additional quantity of water, and mixing,
forming dough pieces, in particular on a forming-machine type apparatus,
resting the dough pieces thus formed,
laminating operation, the latter most generally comprising several successive laminations, and optionally cutting,
weighing of the various ingredients of the topping, and then mixing said ingredients, optionally accompanied by grinding,
depositing the topping thus prepared on the laminated and optionally cut dough, and spreading the topping,
depositing the other ingredients in pieces and grated cheese on the dough,
cooking, preferably on wood fire, for a sufficient time to obtain the desired coloration,
optionally deep-freezing,
individual packaging of the products with topping thus obtained.

14. The method as claimed in claim 13, characterized in that the dough pieces have a weight of about 200 grams, and in that the dough rest time lasts for about 5 minutes to 30 minutes.
